(19) United States
(12) Patent Application Publication
(10) Pub. No.: US 2009/0107448 A1
(43) Pub. Date: Apr. 30, 2009

(54) AGGREGATE CARRIER

(75) Inventors: Wolf-Dietrich Bicker, Trebur (DE); Jurgen Herchenroder, Russelsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/260,029

(22) Filed: Oct. 28, 2008

(30) Foreign Application Priority Data
Oct. 30, 2007 (DE) 102007051717.5

(51) Int. Cl. F02B 67/00

(52) U.S. Cl. 123/195 A; 74/11

(57) ABSTRACT

An aggregate carrier is provided for an internal combustion engine of a motor vehicle that serves to connect motor vehicle aggregates to the internal combustion engine and for this purpose includes, but is not limited to a first mount to be connected to the internal combustion engine. The first mount is realized in such a way that a force can be exerted upon the internal combustion engine in a first mounting direction. The aggregate carrier furthermore features a second mount to be connected to the internal combustion engine. The second mount is realized in such a way that a force can be exerted upon the internal combustion engine in a second mounting direction. The second mounting direction extends at an angle α relative to the first mounting direction.

### CROSS-REFERENCE TO RELATED APPLICATION

This application claims priority to German Patent Application No. 102007051717.5, filed Oct. 30, 2007, which is incorporated herein by reference in its entirety.

### TECHNICAL FIELD

The technical field pertains to an aggregate carrier for an internal combustion engine of a motor vehicle, by means of which motor vehicle aggregates such as, for example, a generator for charging a motor vehicle battery can be connected to the internal combustion engine.

### BACKGROUND

An internal combustion engine usually features an oil pan, onto which an engine block is attached. A cylinder head is then attached onto the engine block. In order to connect other motor vehicle aggregates such as, for example, a generator for charging a motor vehicle battery to the internal combustion engine, it is known to mount an aggregate carrier on the engine block such that it is not necessary to adapt the geometry of the engine block with a casting to the geometry of the respective motor vehicle aggregate. In this case, the aggregate carrier is connected to the engine block with the aid of screws that are horizontally screwed into internally threaded pocket holes of the engine block.

The disadvantage of such an aggregate carrier is that the space required for mounting several motor vehicle aggregates is very limited although there is a need to connect more and more motor vehicle aggregates to the internal combustion engine. The utilization of several aggregate carriers is disadvantageous because this would increase the installation expenditures. It would also be disadvantageous to use a larger aggregate carrier because the installation would be more complicated due to the increased weight of the aggregate carrier and it would also be necessary to connect the aggregate carrier to the internal combustion engine by means of more than one component such that installation inaccuracies would result.

In view of the foregoing, at least one objective exists to develop an aggregate carrier, by means of which motor vehicle aggregates can be connected to the internal combustion engine and the required installation accuracies can be observed without increasing the installation expenditures. In addition, other objectives, desirable features and characteristics will become apparent from the subsequent summary and detailed description of the invention, and the appended claims, taken in conjunction with the accompanying drawings and this background.

### SUMMARY

The aggregate carrier for an internal combustion engine of a motor vehicle in accordance with an embodiment of the invention serves for connecting motor vehicle aggregates to the internal combustion engine and features a first mounting means and a second mounting means that are respectively connected to the internal combustion engine. The first mounting means to be connected to the internal combustion engine is realized in such a way that a force can be exerted upon the internal combustion engine in a first mounting direction. The second mounting means to be connected to the internal combustion engine is realized in such a way that a force can be exerted upon the internal combustion engine in a second mounting direction. According to an embodiment of the invention, the second mounting direction is angled relative to the first mounting direction. The angle between the first mounting direction and the second mounting direction may amount to less than or equal to about 90°±20°, preferably less than or equal to about 90°±10°, especially less than or equal to about 90°±5°, and particularly less than or equal to about 90°±1°. The first mounting means and/or the second mounting means preferably feature(s) a through-opening, particularly an oblong hole for screwing the aggregate carrier to the internal combustion engine, such that the aggregate carrier can be connected to the internal combustion engine with the aid of screws.

The different mounting directions of the first mounting means and the second mounting means make it possible to achieve an automatic self-alignment of the aggregate carrier when it is connected to the internal combustion engine due to the different directions of force. If the mounting means are connected by means of a screw connection, the screws initially can be only screwed in partially such that the aggregate carrier can be precisely aligned and adjusted shortly before it is fixed on the internal combustion engine. Even if the aggregate carrier is held by a crane during this process, a precise installation, in which the required installation accuracies are observed, can be easily realized without increasing the installation expenditures. The aggregate carrier therefore can be realized much larger in order to connect more motor vehicle aggregates to the internal combustion engine. If the mounting means feature oblong holes, in particular, an exact alignment and correction can be realized such that the aggregate carrier can also be connected to more than one component of the internal combustion engine. For example, the aggregate carrier can be connected to the engine block and to the oil pan and/or the cylinder head. The alignment of the aggregate carrier relative to the internal combustion engine can be realized in a particularly simple fashion if the mounting directions are essentially aligned perpendicular to one another such that the alignment in one mounting direction can not impair the alignment in the other mounting direction.

In one preferred embodiment, the first mounting direction essentially extends horizontally, particularly for the mounting on an engine block of the internal combustion engine, and the second mounting direction essentially extends vertically, particularly for the mounting on an oil pan of the internal combustion engine. This makes it possible to initially place the aggregate carrier to be connected to the internal combustion engine on the oil pan such that the installer does not have to hold the entire weight of the aggregate carrier during the installation. It is also unnecessary to hold the aggregate carrier with the aid of a crane. The option of mounting the aggregate carrier with the aid of a crane may be advantageous as an additional safety measure only.

The aggregate carrier preferably features at least one aggregate mounting, on which at least one motor vehicle aggregate can be mounted, particularly an air-conditioning compressor, a generator, a steering booster, at least one belt deflection pulley and the like. It is particularly preferred that the aggregate carrier features several aggregate mountings such that it is possible to connect as many motor vehicle aggregates as possible by means of the same aggregate carrier.

The embodiments of the invention furthermore pertain to an internal combustion engine that features an oil pan and an engine block that is connected to the oil pan. Furthermore, an aggregate carrier is provided that may be realized and additionally developed as described above. The aggregate carrier is connected, particularly screwed, to the engine block and to the oil pan. The oil pan preferably features a protruding lug that forms a seat. The aggregate carrier may be supported on the seat in the installed state. It is particularly preferred that the oil pan features a mounting flange, by means of which the engine block can be connected to the oil pan. In one particularly preferred embodiment, the seat protrudes from the mounting flange. This makes it possible to create the seat with a measure that can be easily realized with respect to the casting technology, and the seat is arranged in a plane that is processed by means of cleaning anyway. Furthermore, the cleaning process produces a smooth seat, on which the aggregate carrier can be easily pushed against the internal combustion engine, particularly the engine block.

The embodiments of the invention furthermore pertain to a method for connecting an aggregate carrier to an internal combustion engine, wherein the aggregate carrier may be realized and additionally developed as described above. In this method, an oil pan is initially supplied and an engine block is connected to the oil pan. The aggregate carrier is placed on a part of the oil pan. Subsequently, the aggregate carrier is connected to the engine block, and the aggregate carrier can be pushed against the engine block in this step. The aggregate carrier is mounted on the oil pan after it is mounted on the engine block. This method makes it possible to connect an aggregate carrier that may carry several motor vehicle aggregates to the internal combustion engine such that installation accuracies are observed, without increasing the installation expenditures. The engine block, in particular, does not have to be connected to the oil pan in a precisely fitted fashion, for example, with the aid of fitting sleeves because the required alignment of the aggregate carrier is realized during its installation and installation inaccuracies between the engine block and the oil pan can be automatically compensated. Consequently, the engine block preferably can be connected to the oil pan with a certain tolerance in the inventive method. This simplifies the installation of the internal combustion engine and lowers the costs because no complicated and highly precise connecting elements are required between the engine block and the oil pan.

### BRIEF DESCRIPTION OF THE DRAWINGS

The present invention will hereinafter be described in conjunction with the following drawing figures, wherein like numerals denote like elements, and

FIG. 1 shows a schematic perspective representation of an aggregate carrier;

FIG. 2 shows a schematic side view of the aggregate carrier according to FIG. 1;

FIG. 3 shows a schematic perspective representation of the aggregate carrier according to FIG. 1 prior to the mounting on an oil pan;

FIG. 4 shows a partially sectioned schematic side view of the aggregate carrier according to FIG. 3 in the installed state;

FIG. 5 shows a schematic perspective exploded view of an internal combustion engine with the aggregate carrier according to FIG. 1, and

FIG. 6 shows a schematic perspective representation of the internal combustion engine according to FIG. 5 in the installed state.

### DETAILED DESCRIPTION

The following detailed description is merely exemplary in nature and is not intended to limit application and uses. Furthermore, there is no intention to be bound by any theory presented in the preceding background and summary or the following detailed description.

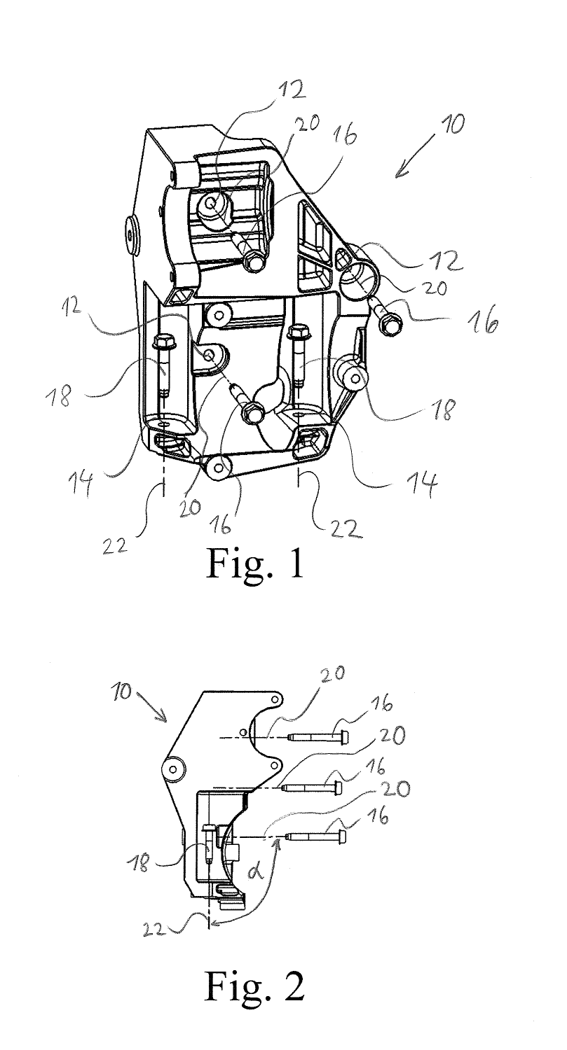

The aggregate carrier 10 illustrated in FIG. 1 features several first mounting means 12 in the form of through-holes and several second mounting means 14 in the form of through-holes. A first screw 16 is assigned to each through-hole of the first mounting means 12. Accordingly, a second screw 18 is respectively assigned to each through-hole of the second mounting means 14. The first screws 16 or the first mounting means 12 have a first mounting direction 20 that is essentially aligned horizontally. The second screws 18 or the second mounting means 14 have a second mounting direction 22 that is essentially aligned vertically.

Due to the different alignment of the second mounting direction 22 relative to the first mounting direction 20, an angle α of essentially 90° is formed between the first mounting direction and the second mounting direction 22 (FIG. 2).

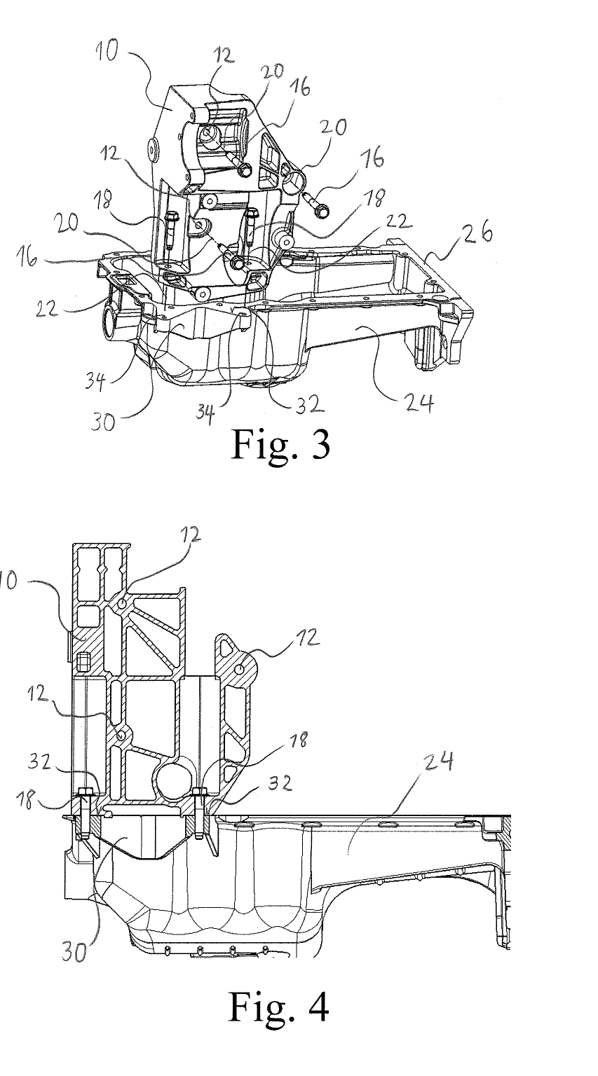

According to FIG. 3, an oil pan 24 may be provided that features a mounting flange 26 for mounting an engine block 28, from which a lug 30 protrudes. Due to the lug 30, the oil pan 24 forms a seat 32 that lies in the same plane as the mounting flange 26.

In the installed state (see FIG. 4), the aggregate carrier 10 is supported on the seat 32. The aggregate carrier 10 can be connected to the oil pan 24 by means of the second screws 18 that are screwed into the through-holes with internal threads 34.

In order to ensure that the oil pan 24 can be easily removed in a service instance, the aggregate carrier 10 is realized, in particular, in such a way that the screws 18 on the oil pan 24 are freely accessible and it is not necessary to remove any aggregates 46. Consequently, the aggregate carrier 10 may remain connected to the engine block 28 if the oil pan 24 needs to be removed such that the installation expenditures for the service instance are comparatively low.

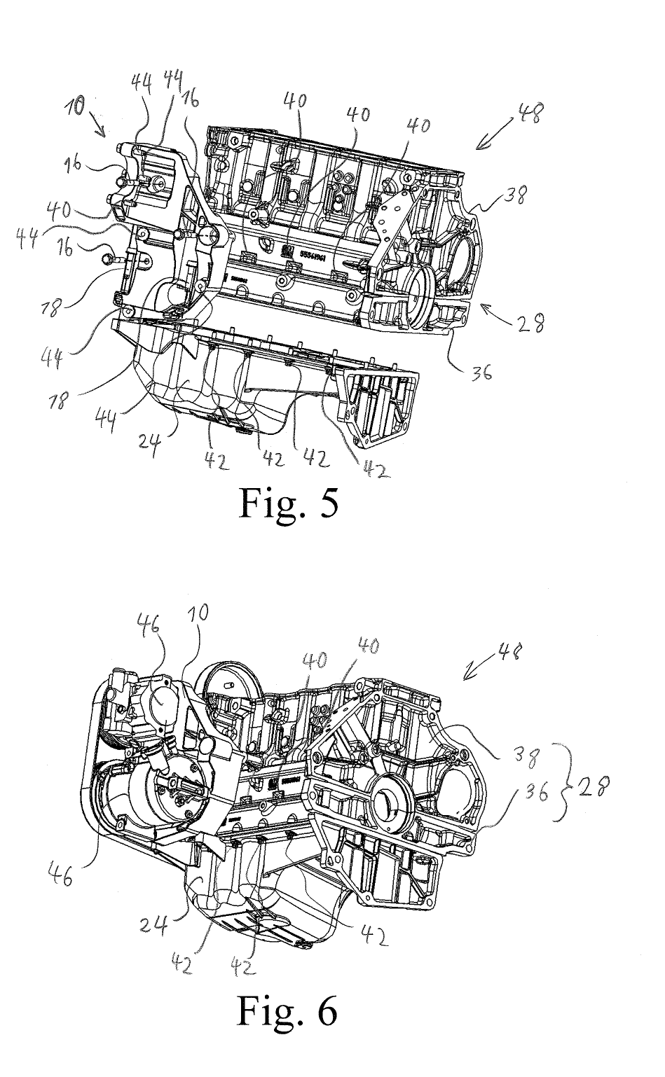

According to FIG. 5, the aggregate carrier 10 is realized so large that it can be connected to the oil pan 24, as well as to the engine block 28. In the embodiments shown, the engine block 28 has several parts and features a lower half 36 and an upper half 38. In the embodiment shown, the lower half 36 is connected to the upper half 38 by means of a connections 40. The engine block 28 may be connected to the oil pan 24 by means of screw connections 42. In the embodiment shown, the aggregate carrier 10 may be screwed to the oil pan 24, as well as to the lower half 36 and the upper half 38 of the engine block 28.

The aggregate carrier 10 features several aggregate mountings 44, by means of which motor vehicle aggregates 46 can be mounted on the aggregate carrier 10 (FIG. 6). The cylinder head of the internal combustion engine 48 is not illustrated in order to provide a better overview.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An aggregate carrier for an internal combustion engine of a motor vehicle that serves for connecting motor vehicle aggregates to the internal combustion engine comprising:
a first mount adapted for connection to the internal combustion engine and further adapted to exert a force upon the internal combustion engine in a first mounting direction; and
a second mount adapted for connection to the internal combustion engine and further adapted to exert the force upon the internal combustion engine in a second mounting direction,
wherein the second mounting direction extends at an angle (α) relative to the first mounting direction.

2. The aggregate carrier according to claim 1, wherein the angle (α) between the first mounting direction and the second mounting direction amounts to less than or equal to about 90°±20°.

3. The aggregate carrier according to claim 1, wherein the angle (α) between the first mounting direction and the second mounting direction amounts to less than about 90°±10°.

4. The aggregate carrier according to claim 1, wherein the angle (α) between the first mounting direction and the second mounting direction amounts to less than about 90°±5°.

5. The aggregate carrier according to claim 1, wherein the angle (α) between the first mounting direction and the second mounting direction amounts to less than about 90°±1°.

6. The aggregate carrier according to claim 1, wherein the first mounting direction essentially extends at least substantially horizontally for a mounting on an engine block of the internal combustion engine and the second mounting direction essentially extends at least substantially vertically for a mounting on an oil pan of the internal combustion engine.

7. The aggregate carrier according to claims 1, wherein at least one of the first mount or the second mount comprises a through-opening adapted to receive a screw for connecting the aggregate carrier to the internal combustion engine.

8. The aggregate carrier according to claim 1, further comprising an aggregate mounting adapted to mount at least one of the motor vehicle aggregates.

9. The aggregate carrier according to claim 1, wherein the at least one of the motor vehicle aggregates is an air-conditioning compressor.

10. The aggregate carrier according to claim 1, wherein the at least one of the motor vehicle aggregates is a generator.

11. The aggregate carrier according to claim 1, wherein the at least one of the motor vehicle aggregates is a power-steering pump.

12. The aggregate carrier according to claim 1, wherein the at least one of the motor vehicle aggregates is a belt deflection pulley.

13. An internal combustion engine, comprising:
an oil pan;
an engine block connected to the oil pan; and
an aggregate carrier connected to the engine block and the oil pan, the aggregate carrier comprising:
a first mount adapted for connection to the internal combustion engine and further adapted to exert a force upon the internal combustion engine in a first mounting direction; and
a second mounting adapted for connection to the internal combustion engine and further adapted to exert the force upon the internal combustion engine in a second mounting direction, wherein the second mounting direction extends at an angle (α) relative to the first mounting direction.

14. The internal combustion engine according to claim 13, wherein the oil pan comprises a protruding lug adapted to support the aggregate carrier.

15. The internal combustion engine according to claim 13, wherein the oil pan comprises a mounting flange adapted to connect the engine block to the oil pan and a seat protrudes from the mounting flange that is adapted to support the aggregate carrier.

16. The internal combustion engine according to claim 13, wherein the angle (α) between the first mounting direction and the second mounting direction amounts to less than or equal to about 90°±20°.

17. The internal combustion engine according to claim 13, wherein the angle (α) between the first mounting direction and the second mounting direction amounts to less than about 90°±10°.

18. The internal combustion engine according to claim 13, wherein the angle (α) between the first mounting direction and the second mounting direction amounts to less than about 90°±5°.

19. The internal combustion engine according to claim 13, wherein the angle (α) between the first mounting direction and the second mounting direction amounts to less than about 90°±1°.
